(19) United States
(12) Patent Application Publication
(10) Pub. No.: US 2004/0221672 A1
(43) Pub. Date: Nov. 11, 2004

(54) Enveloping worm transmission

(76) Inventor: Yakov Fleytman, Lake Orion, MI (US)

Correspondence Address: YAKOV FLEYTMAN, 3233 HICKORY DRIVE, LAKE ORION, MI, 48359, US

(21) Appl. No.: 10/435,143

(22) Filed: May 9, 2003

Related U.S. Application Data
(60) Provisional application No. 60/464,044, filed on Apr. 21, 2003.

(51) Int. Cl. F16H 1/16

(52) U.S. Cl. 74/425

(57) ABSTRACT

An enveloping worm transmission is provided with a unique enveloping worm and worm gear with modified enveloping worm thread surfaces. Enveloping worm has two general arrangements with worm gear: on the top and on the face of worm gear. The enveloping worm gear transmission is more efficient, quite and compact than conventional hypoid gear systems which have typically been used in power applications. The enveloping worm transmission of the present invention is easy manufacturing.

This application claims the benefit of provisional application Serial No. 60/464044 filed on Apr. 21, 2003

### FIELD OF THE INVENTION

An enveloping worm transmission is suitable for the transformation of motion and power between an enveloping worm and a worm gear wherein the axis of the worm gear and the worm may be crossed or intersected. The enveloping worm transmission includes one or multi-thread enveloping worm engaged with a worm gear. The worm gear has teeth generated by enveloping worm threads. The enveloping worm transmission allows for low or high speeds, high load applications such as helicopter or automobile gearboxes, front and rear drive axles, power take—off units, and turbine gearboxes. Certain applications may be outside of these fields, like power windows, doors or seats, power steering systems, chainless bicycle drive mechanism, and many industrial applications.

### BACKGROUND OF THE INVENTION

Worm/worm gear transmissions, in particular double enveloping speed reducers or Cone drive worm/worm gears, are well known in the mechanical power transmission field. The worm gear is driven by the rotation of the worm with which it meshes. The rotational speed of the associated shaft of the worm gear is a function of the number of teeth on the worm gear and the number of threads on the worm. The worm may be single or multiple threaded. In all standard double enveloping worm/worm gear transmissions, the enveloping worm gear has a surface that is generated by the profile of an enveloping thread of the worm. The term “Generated” describes how the profile of a worm gear tooth may be defined. It could utilize mathematical calculations defining the profile from equations of the surface of the enveloping worm thread; hobbing of a gear blank by a tool, having the profile of the worm thread; or via computer modeling, where the profile of a 3D solid worm gear is cut by the profile of a 3D solid worm thread. Conventional enveloping worm/worm gear transmissions are using worm thread with at least one revolution of the thread or 360 degrees of revolution. Drive face of the thread has a concave and a convex surface and coast face of the thread also has concave and convex surfaces.

According to the Popov (U.S. Pat. No. 4,047,449), in order to increase the amount of tooth contact by increasing the number of teeth in actual contact, the enveloping worm has more than one revolution of the thread.

The McCartin patent (U.S. Pat. No. 3,597,990) discloses a transmission with enveloping worm meshed with threaded followers. Thus, the McCartin gear with threaded followers is not able to have an envelope profile. Profiles of standard enveloping worm gear teeth usually have a profile generated by hobbing. However, the McCartin thread followers could not be made by hobbing or by generation of the worm thread profile. McCartin drive is used for indexing motion and does not have a self-lock feature. McCartin patent can use one thread with more than two revolutions for accurate indexing.

In my patent (U.S. Pat. No. 6,093,126), there is a split enveloping worm. However, the splitting halve is able to transmit motion only in one direction. To reverse the direction of motion it uses the other half This means that only one surface of the worm thread is able to transmit motion. Each side of a thread has a concave surface and a convex surface. Only the concave surface is able to transmit torque and the convex surface doesn't have any mesh with a gear's tooth. This problem is present in all existing transmissions with an enveloping worm (Faydor Litvin 1994, Gear Geometry and Applied Theory. PTR Prentice Hall, Englewood Cliffs, N.J. pages 599-612). In my patents U.S. Pat. No. 5,992,259 and U.S. Pat. No. 6,148,683 the enveloping worm and the worm gear can be one half or less of a split worm, which can have only one supporting shaft. Using only half or less than a half of the split worm gear or enveloping worm allows for easier assembly of the enveloping worm with the worm gear. The enveloping worm according with my patent mentioned above is also able to transmit motion by concave side of the thread with very good surface contact and by convex part of the thread despite very poor contact between surfaces of worm thread and gear tooth. The convex part of the enveloping worm thread has good contact with half of the gear width and the contact by the edge of the thread with another half of the gear.

Contact by the edge of the enveloping worm thread prevents the use of the enveloping worm in different types of gear transmissions, like a hybrid gear drive U.S. Pat. No. 6,128,969 or any well known face gear transmissions: hypoid or spiral bevel.

These limitations are the reason to modify the worm thread to eliminate useless parts of the thread and the gear teeth and to make new types of the gear transmissions with an enveloping worm more efficient.

### SUMMARY OF THE INVENTION

Enveloping worm transmission with teeth surface generated by profile of a thread where an enveloping worm having at least one screw thread that is engaged by at least one tooth of said worm gear has limitations to transferring torque mostly by concave surface of the worm thread. It is also very important to use an enveloping pinion with different types of the worm gears, like face gears. It is convenient to generate enveloping worm thread profile by the base profile of the involutes rack (cutter) rolls around the base circle where the pinion tooth section is always on the same angle to the gear circle. It does not roll around it, it just transfers around it. The position of an enveloping worm thread in mesh with a worm gear placed on the axis of the base circle is the original position. I would like to keep the original enveloping worm's thread surface unattached but to change the orientation of convex surface of the thread to be able to have good mesh with a worm gear tooth. Also, I want to change orientation of concave surface of the thread to improve mesh between worm gear tooth and concave surface of the enveloping worm thread. The efficiency of the new enveloping worm transmission is even greater than that of well-known hypoid gearsets which are used in low ratio right angle drives. Thus, the present invention can replace hypoid or bevel gearing in many applications by reason of high efficiency for low ratio.

In addition, by transmitting torque this new enveloping worm transmission is able to back drive from the worm gear to the enveloping worm. For the same size of the pinion, this invention has almost twice the torque capacity of traditional hypoid gearing. Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIGS. 1, 2 and 3 show an enveloping worm transmission utilizing a modified enveloping worm with less than one revolution of threads;

FIG. 4 is a side view of a worm gear having taped shape;

FIG. 5 is a sectional view of an enveloping worm transmission with an enveloping worm threads and worm gear teeth having asymmetric profile;

FIG. 6 is a view of a 360 degree thread of an enveloping worm engaged with a worm gear;

FIG. 7 is a view of a 360 degree thread of an enveloping worm marked every 90 degrees of revolution;

FIG. 8 is a view of a 180 surface of a thread of an enveloping worm marked every 90 degrees of revolution;

FIG. 9 is a view of a worm gear tooth with three different surfaces;

FIG. 10 is combinations of worm thread surface displacements for part A of the thread;

FIG. 11 is combinations of worm thread surface displacements for part B of the thread;

FIG. 12 is combinations of worm thread surface displacements for parts A and B of the thread;

FIG. 13 shows an enveloping worm gear transmission according to the principles of the present invention, where an enveloping threads of an enveloping worm are modified;

FIG. 14 is a sectional view of worm gears for the different design combinations with 360 degree of an enveloping worm;

FIG. 15 is a sectional view of worm gears for the different design combinations with an enveloping worm with less than one revolution of threads;

FIG. 16 is an isometric view of the enveloping worm transmission with a thread having less than 90 degrees of revolution and with higher ratio than enveloping worm transmission in FIG. 10;

FIG. 17 is a view of a 360 degree thread of an enveloping worm and a face gear;

FIG. 18 is a plan view of a design with enveloping worm placed in the middle of the face of worm gear with enveloping worm having less than 180 degrees of revolution of threads;

FIG. 19 is an isometric view of a design with enveloping worm placed in the middle of the face of worm gear with enveloping worm having less than 180 degree of revolution of threads;

FIG. 20 is a plan view of a design with an enveloping worm placed on the face of worm gear with offset and with enveloping worm having 90 degrees of revolution of a thread;

FIG. 21 is an isometric view of a design with an enveloping worm placed on the face of worm gear with offset and with enveloping worm having 90 degrees of revolution of threads;

FIG. 22 is a plan view of a design with 180 degree of thread revolution of an enveloping worm placed on the face of a worm gear;

FIG. 23 is an isometric view of a design with 180 degree of thread revolution of an enveloping worm placed on the face of a worm gear;

FIG. 24 is a plan view of a design with an enveloping worm placed on the face of worm gear with enveloping worm having 90 degrees of revolution of threads, where the enveloping worm is designed for highest ratio enveloping worm transmission shown in FIG. 16;

FIG. 25 is an isometric view of a design with an enveloping worm placed on the face of worm gear with enveloping worm having 90 degree of revolution of threads, where the enveloping worm is designed for highest ratio enveloping worm transmission shown in FIG. 16;

FIG. 26 is a plan view of a design with an enveloping worm and worm gear with parallel shafts according to the principles of the present invention;

FIG. 27 is an isometric view of a design with an enveloping worm and worm gear with parallel shafts according to the principles of the present invention;

FIG. 28 is a plan view of a design with an enveloping worm gear transmission with less than 90 degrees between worm axes and face worm gear axes according to the principles of the present invention;

FIG. 29 is an isometric view of a design with an enveloping worm gear transmission with less than 90 degrees between worm axes and face worm gear axes according to the principles of the present invention;

FIG. 30 is a sectional view of an enveloping worm in mesh with a worm gear where the worm gear is inside of the enveloping worm;

FIG. 31 is a view of the enveloping worm with an inverted envelope in mesh with a worm gear where an enveloping worm is inside of the worm gear;

FIG. 32 is a sectional view of worm gears for different design combinations of a worm inside of the worm gear;

FIG. 33 is a view of a 360 degree thread of an enveloping worm and a worm gear having profile of helical gear;

FIG. 34 is a plan view of a design with an enveloping worm gear having profile of helical gear and an enveloping worm having less than one revolution of threads;

FIG. 35 is an isometric view of a design with an enveloping worm gear having profile of helical gear and an enveloping worm having less than one revolution of threads;

FIG. 36 shows a machine setting for manufacturing modified thread of an enveloping worm.

### DETAILED DESCRIPTION OF THE PREFERRED EMBODIMENTS

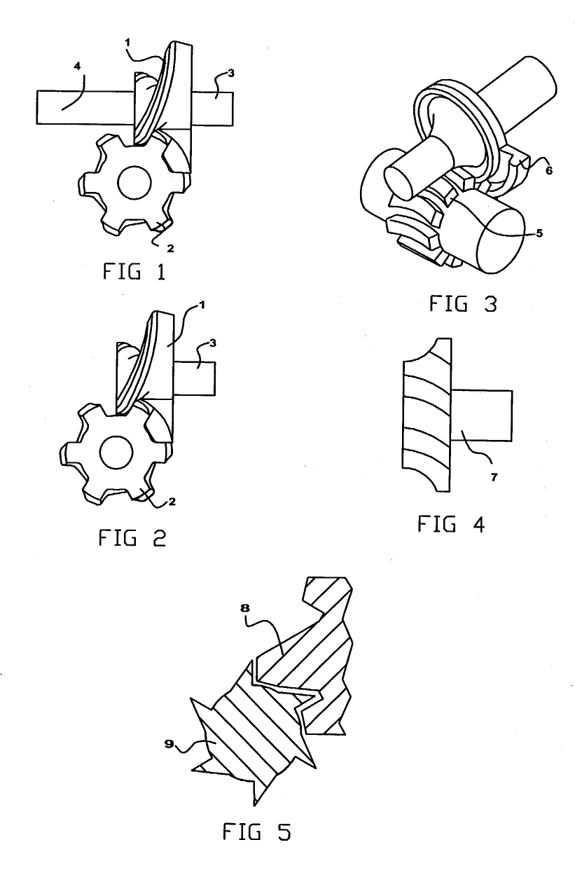

The following discussion relating to FIGS. 1-36 provides a detailed description of the unique enveloping worm gear transmissions which can be utilized with the present invention.

More torque capacity is the main advantage for using the enveloping worm transmission. For various torque capacities, the enveloping worm transmission could have different enveloping angles. The worm thread mostly has a rolling action contact relationship with the teeth of the worm gear which provides an increased efficiency. With standard worm designs, having more than one thread and a large enveloping angle, the inability to assemble the worm and worm gear was considered a major obstacle. With the enveloping worm and worm gear of the present invention, the enveloping worm and worm gear are easily assembled by properly orienting the worm thread and worm teeth. According to the present invention, the greater enveloping angle for one revolution of a worm thread permits the use of worm gear teeth without undercut portions.

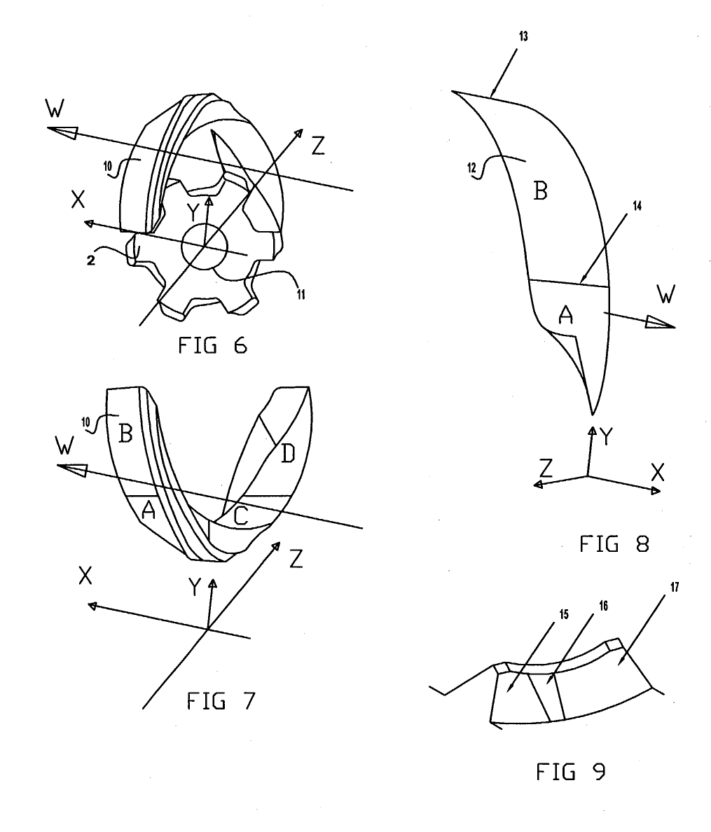

Referring now to the drawings, one embodiment of an enveloping worm transmission of the present invention is illustrated in FIG. 1. It consists of enveloping worm 1 which engages with worm gear 2. Enveloping worm 1 has two supporting shafts, 3 and 4. Enveloping worm transmission in FIG. 2 has only one supporting worm 1, shaft 3. FIG. 3 illustrates self-locking enveloping worm transmission, where tooth 5 of the worm gear is generated by the surfaces of thread 6. FIG. 4 illustrates taped shape of the worm gear with one supporting shaft 7 for non-locking enveloping transmission. This shape could be useful for mass production of enveloping worm transmission by forging, casting or injection molding.

FIG. 5 is a sectional view of the mesh between the enveloping worm and the worm gear, where worm thread 8 and worm gear tooth 9 have asymmetric profile. It could be useful for self-locking transmissions.

FIG. 6 is a 360 degree (one revolution) view of thread 10 that is generated by using a base circle 11. The coordinate system X, Y, Z is located in the center of the base circle 11. Thread 10 is located symmetric to plane ZY. We have the original position of the thread, where the thread is usually used in double enveloping worm worm/gear transmissions and we have the original position of surfaces on one side of the thread and on another side (drive and coast surfaces) of the enveloping worm. Original position of the enveloping worm thread is the position of the thread where it was generated by rolling a cutter around base circle with simultaneous rotation of enveloping worm blank. Original position of an enveloping worm thread surface is the position on the thread where the surface was generated by rolling a cutter around base circle with simultaneous rotation of enveloping worm blank. Worm gear 2 shows the ends of thread 10. FIG. 7 is a location of generated thread 10 with drive and coast surfaces after rolling straight cutting edge around base circle 11. The enveloping worm surfaces on thread 10 are in the original position. FIG. 7 is a view of thread 10 in location used for further modifications of the thread's surfaces. The location of the enveloping worm thread 10 could be in any angular location around the axis of rotation of the enveloping worm. In other words, it could be in any location of the enveloping worm thread where it is engaged by at least one tooth of the worm gear for the cycle of rotation around the enveloping worm axis of rotation. For example, the location of the thread 10 in FIG. 7 is rotated 180 degrees around worm axis of rotation W from that in FIG. 6. The thread is split into two halves with parts AB and CD using XY plane. Each halve of thread 10 was further split into parts A, B, C and D using plane locating on the axes W of thread 10 (worm) rotation, parallel to plane ZY. Parts A and C have smaller lead angle than parts B and D. This thread has a convex surface on parts A and B (marks A and B are placed on the convex surfaces) and a concave surface on the parts C and D (marks C and D are placed on the concave surfaces). Each convex surface on one side of the thread becomes the concave surface and each concave surface of another side of the thread becomes the convex surface. FIG. 8 is a view of the convex surface 12 extracted from parts A and B of the thread 10. Part B has a bigger lead angle than part A. Surface 12 has edge 13 and edge 14 between parts A and B. FIG. 9 is a view of a worm gear tooth with three different surfaces, 15, 16 and 17 (Faydor Litvin 1994, Gear Geometry and Applied Theory. PTR Prentice Hall, Englewood Cliffs, N.J. page 610). It is well known that a 360 degree of revolution enveloping worm thread generates very complicated worm gear tooth profile, where a proper worm gear tooth surface is part 14, FIG. 9. Surfaces 15 and 17 are generated by the edge of thread. For 180 degree revolution of a worm thread, the thread generates gear tooth profile with only two parts 15 and 16. In enveloping worm transmission without thread modification with 180 degree of the thread, the concave part of the thread 12 generates one gear tooth profile by moving along the tooth profile, but the convex part of the thread generates two independent gear tooth surfaces: one by edge 13 and another by edge 14 for the same side of the gear profile. In reality it finally generates the surface which is closer to a worm gear axis of rotation. If we will use unmodified 180 degree worm thread we will make only non reversible transmission where we have mesh of concave part of a thread that is able to transmit torque. When we will have mesh by convex part of a thread we will have very poor contact between gear tooth surface and worm thread edge. Many production companies have techniques for modifying a worm thread profile to avoid generation of the gear profile by the edge of a thread. They change the position of the cutter but they don't change a cutting plane. They machine modified concave and convex surfaces of the enveloping worm thread from the same position of a cutter. For example one book (Faydor Litvin 1994, Gear Geometry and Applied Theory. PTR Prentice Hall, Englewood Cliffs, N.J. page 611) illustrates that modifications solve the problem but the shape of contact lines is less favorable. Another example where worm gear has a predetermined surface is well known as Wildhaber enveloping transmission U.S. Pat. No. 1,903,318, U.S. Pat. No. 2,935,886. In his enveloping transmission a hob and enveloping worm thread surfaces are generated by spur planes in orthogonal rotating axis and worm gear tooth surfaces is spur plane milled by plane milling cutters. The Wildhaber's idea of modification has serious undercutting and pointing problems on the enveloping worm; that is why it is only used for high gear ratios, more than 1:40. Our goal is to able to generate enveloping worm thread surface by the profile of the cutter, rolls around the base circle and then be able to generate tooth gear profile by surface of the enveloping thread, not the edge of the thread. The surface of worm gear teeth should be generated by the surface of the thread or threads of the enveloping worm using both sides of the thread: convex and concave. To able to generate the enveloping worm thread we generate the enveloping thread surfaces separately; for concave enveloping worm surface from one position of the cutting plane and for the convex enveloping worm surface from another position of the cutting plane. A computer model simulation can be utilized to generate the surface of the worm gear tooth. The worm gear can also be formed using known techniques such as hobbing.

When worm gear teeth are generated by the surface of the enveloping worm threads having different lengths (shortened), the profiles of the worm teeth are different. These principles of the worm thread modification could be applied to any degree of revolution of the worm thread: less than 90, 90, less than 180, 180, less than 360, 360 and more than one revolution of the thread. Longer worm thread has better contact ratio, but for low kinematics ratios (for example, less than 1:8) it is more difficult to manufacture enveloping worm transmission and even to assemble an enveloping worm with a worm gear. From manufacturing position it is more convenient to have asymmetric worm thread. For self-locking enveloping worm transmission it is better to have offset of the worm thread placed on the top of the worm gear in order to illuminate part of the thread with smaller lead angle. To design the worm gear surface we should use common sense: if it is a concave surface of the asymmetric worm thread with more than 180 degrees of revolution generating a gear tooth surface we need to use parts with bigger lead angle. For a convex surface of the asymmetric worm thread with more than 180 degrees of revolution generating a gear tooth profile, we need to use parts with smaller lead angle. The following are examples of modifications of thread surfaces of an enveloping worm 1. The enveloping worm with 180 degrees or less of a thread revolution with concave surface on one side of the thread and convex surface on an opposite side (these are parts A and B on the thread) has only the convex surface of the worm thread modified by repositioning from its original location.

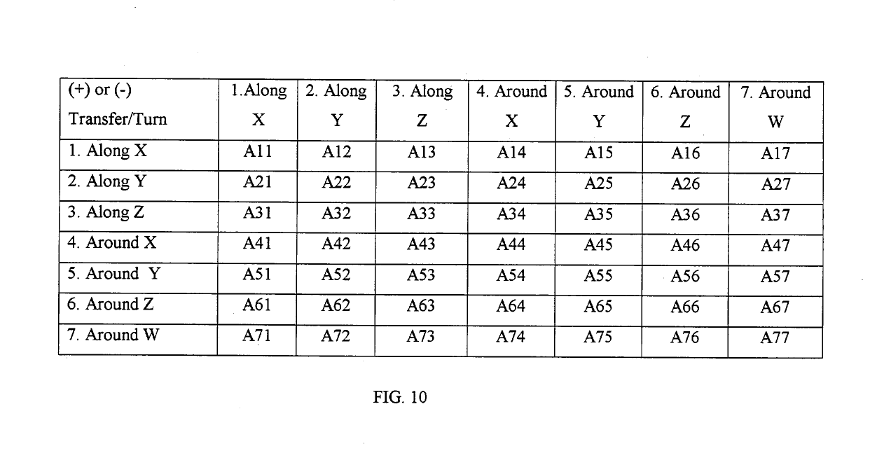

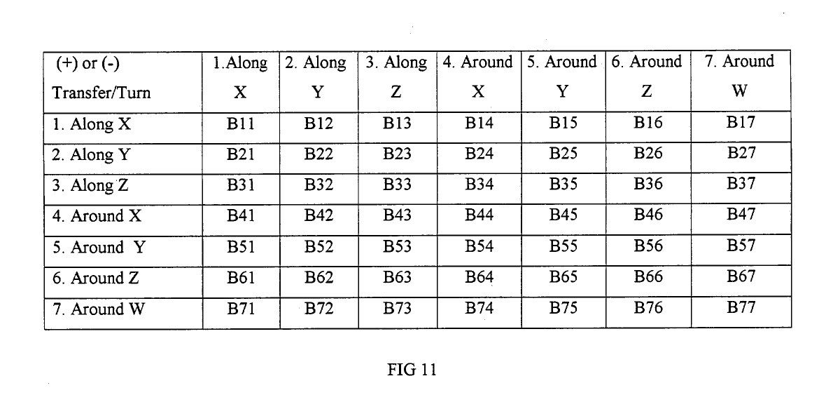

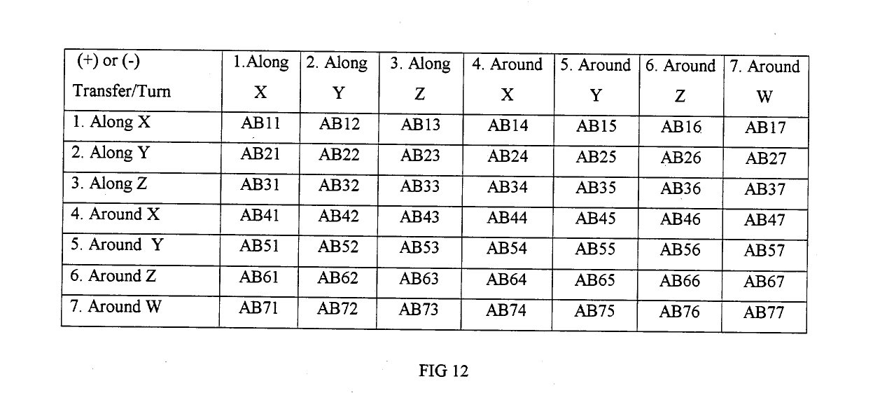

The repositioning could be done using various approaches. FIG. 10, FIG. 11 and FIG. 12 show possible combinations of such reposition for part A, for part B and for parts A and B. The magnitude and direction of the reposition could be defined for each design configuration (ratio, center distance, number of an enveloping threads, number of worm gear teeth) and initial angular position of a thread relative to it axis of rotation. For non-locking enveloping transmission it will defined for concave surface parts A and B but for convex surface just part A. For self-locking transmission it will be defined for concave and convex part B and even for extending thread with more than one revolution, but without part A. For repositioning of the enveloping worm surface we can use more than one combination from FIG. 10, FIG. 11 or FIG. 13. Let's describe in more details modification of the convex geometry of the enveloping worm with surface 12 showing on FIG. 8. Said thread with concave profile is modified by reposition it surface from original position. It will be done by turning around axis Y in the negative direction (approximately 1 degree) and then transferring along axis Y in the negative direction (approximately 1 mm). It is (−A52) in FIG. 10, (−B52) in FIG. 11 and (−AB52) in FIG. 12. For the concave surface of the thread from FIG. 7 this will be done by turning around axis Y in the positive direction and then moving along axis Y in the positive direction. It is (A52) in FIG. 10, (B52) in FIG. 11 and (AB52) in FIG. 12. For enveloping worms that have different direction of thread rotation (counterclockwise versa clockwise) the directions of turning and transferring should be opposite. The reposition of the enveloping worm surface could be done by additional transfer and turning. It will be done by turning around axis Y in the negative direction, then transferring along axis Z in the negative direction and then transferring along axis X in negative direction.

The reposition of worm thread surfaces from their original (not modified) position could be done using any of above transferring and/or turning or different combinations of moving and turning. For some of the modifications, the result could be change of the thickness along the worm thread. For same modifications worm thread has gradually changing thickness which is wide in the smaller lead angle part of the enveloping worm. It is not necessary to turn worm thread surface exactly around above specified axes. It could be different axis, positioned parallel and close to above X, Y, Z and W axes. It is not necessary to transfer worm thread surface exactly along above specified axes. It could be different axis, positioned parallel and close to above X, Y, Z and W axes. Main idea of the present invention is that modification of the enveloping worm thread is done without any deformation or alteration of original geometry of the original enveloping thread. The topology of enveloping thread surfaces is not changed. Changes are present only in the position of repositioned surfaces of enveloping worm thread from original position that were defined by generating original surfaces of the enveloping thread. The result is a new enveloping worm transmission shown in FIG. 13 where enveloping worm 18 is in mesh with worm gear 19 and where enveloping threads of an enveloping worm were modified by changing positions of surfaces according to the principles of the present invention.

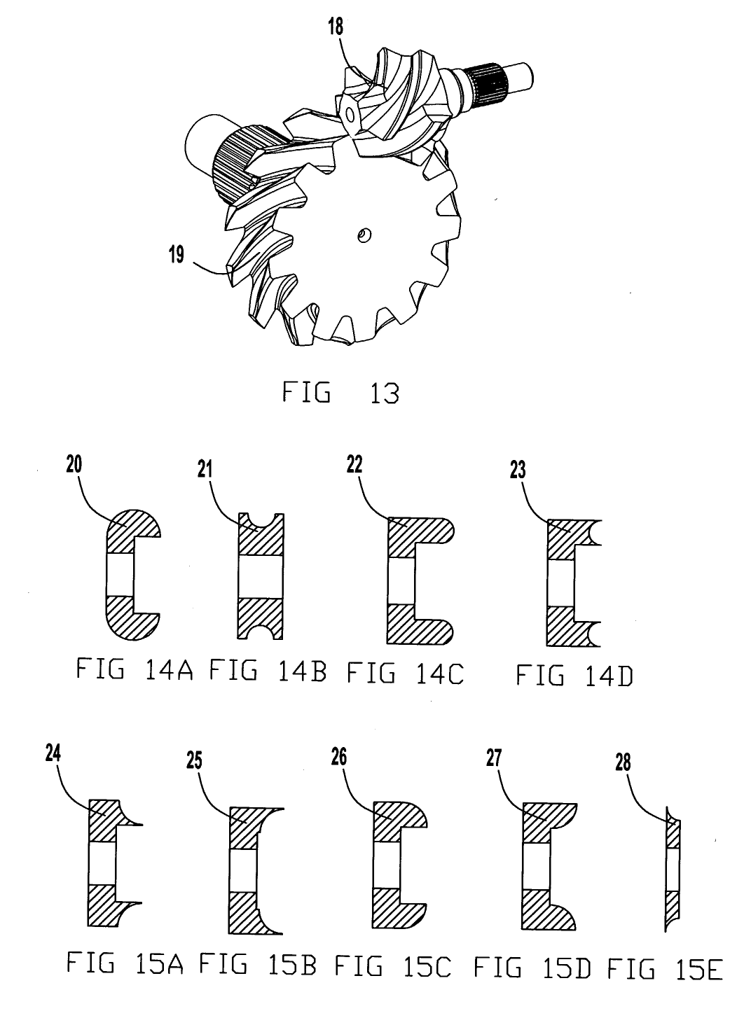

We have combinations of 360 degrees thread worm with the of worm gear and combinations of less than one revolution of the enveloping thread with the worm gear. Possible cross sections of worm gears for 360 degrees or more per revolution of enveloping worm thread are shown in FIG. 14A, FIG. 14B, and FIG. 14C, FIG. 14D with positions 20, 21, 22 and 23 respectfully.

Possible cross sections of worm gears for 180 degrees or less of revolution of enveloping worm thread are shown in FIG. 15A, FIG. 15B, and FIG. 15C, FIG. 15D, FIG. 15E with positions 24, 25, 26, 27, 28 respectfully.

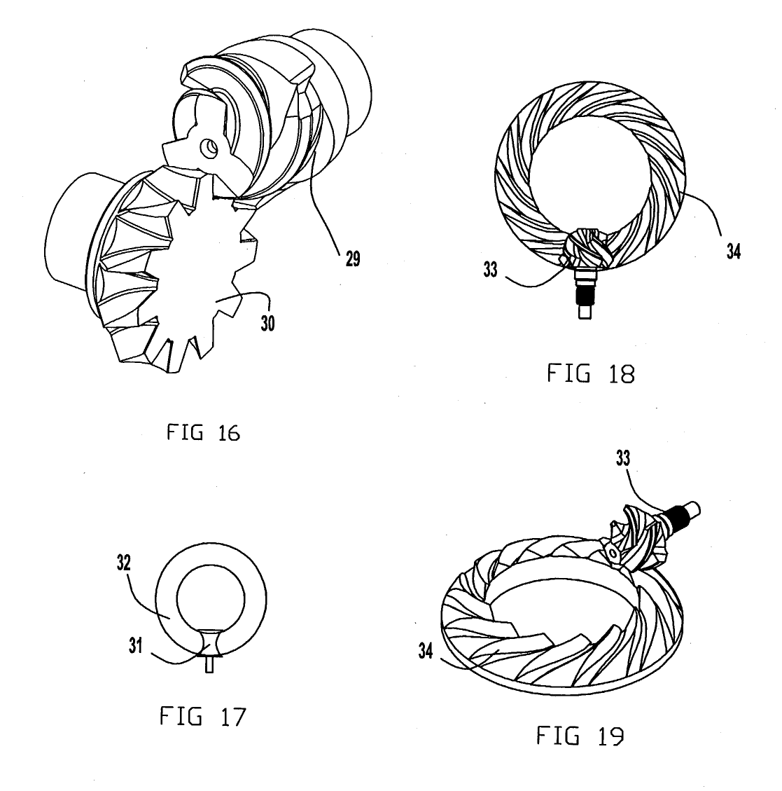

FIG. 16 is an isometric view of the enveloping worm transmission which has enveloping worm 29 and worm gear 30 with a modified thread of less than 90 degrees of revolution, with higher ratio than enveloping worm transmission in FIG. 10.

The same principals, as described above were used for new enveloping worm transmission comprising: a worm gear and an enveloping worm, said enveloping worm having at least one screw thread that is engaged by at least one tooth of said worm gear wherein said worm gear is a face gear and said enveloping worm is placed into face arrangement with said worm gear. In this enveloping worm face transmission the enveloping worm could have any design, however, it is preferred that the enveloping worm be relocated to face arrangement with said worm gear from its original position (where it is usually generated for well known enveloping or double enveloping worm/worm gear transmission). What it is meant by generated is that design of worm thread and topology of surfaces may be generated by rolling cutter around base circle with simultaneous rotation of worm's blank. In reality the profile of enveloping worm thread could be produce from mathematical equations, computer simulation, machined by the special program.

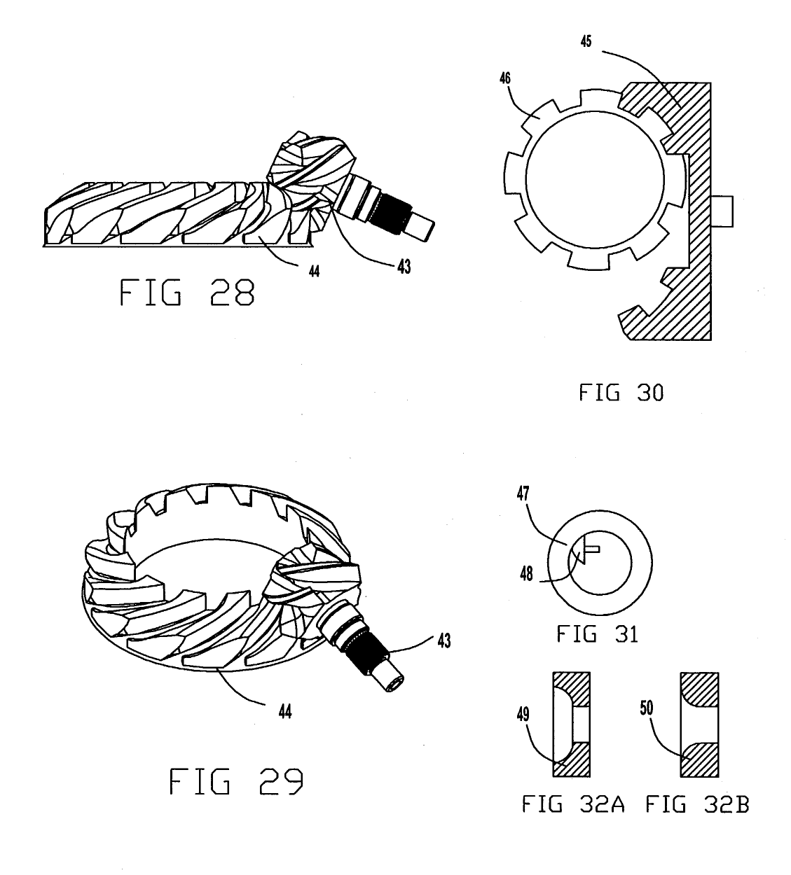

The same enveloping worm thread from FIG. 10 was used in different designs of face gears on the FIG. 18-FIG. 21, FIG. 26, FIG. 27, FIG. 28 and FIG. 29. Surfaces of the thread were repositioned but the topology of the surfaces was not change.

FIG. 17 is a view of a 360 degree thread of an enveloping worm 31 and face gear 32.

FIG. 18 is a plan view of a design with enveloping worm 31 placed in the middle of the face of worm gear 32 with enveloping worm threads having less than 180 degrees of revolution.

FIG. 19 is an isometric view of a design with enveloping worm 33 placed in the middle of the face of worm gear 34 with enveloping worm 33 threads having less than 180 degrees of revolution.

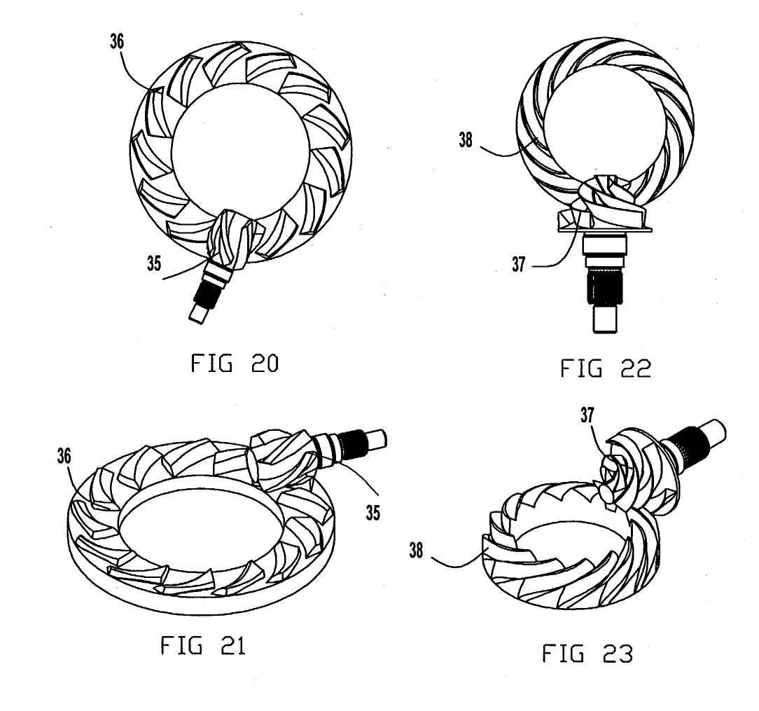

FIG. 20 is a plan view of a design with an enveloping worm 35 placed on the face of worm gear 36 with offset and with enveloping worm threads having 90 degrees of revolution.

FIG. 21 is an isometric view of a design with an enveloping worm 35 placed on the face of worm gear 36 with offset and with enveloping worm threads having 90 degree of revolution.

FIG. 22 is a plan view of a design with 180 degree of thread revolution of an enveloping worm 37 placed on the face of worm gear 38.

FIG. 23 is an isometric view of a design with 180 degrees of thread revolution of an enveloping worm 37 placed on the face of worm gear 38.

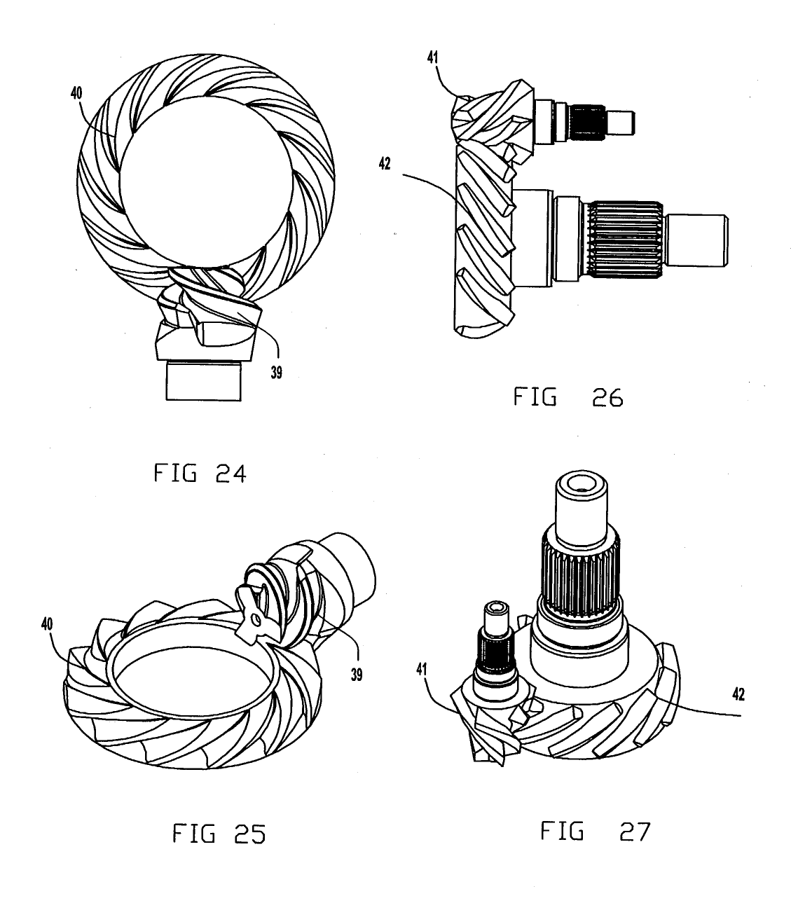

FIG. 24 is a plan view of a design with an enveloping worm 39 placed on the face of worm gear 40 with enveloping worm 39 having 90 degrees of revolution of threads, where the enveloping worm 39 was designed for highest ratio enveloping worm transmission shown in FIG. 16.

FIG. 25 is an isometric view of a design with an enveloping worm 39 placed on the face of worm gear 40 with enveloping worm 39 threads having 90 degrees of revolution, where the enveloping worm 39 was designed for highest ratio enveloping worm transmission shown in FIG. 16.

FIG. 26 is a plan view of a design with an enveloping worm 41 and worm gear 42 with parallel shafts according to the principles of the present invention.

FIG. 27 is an isometric view of a design with an enveloping worm 41 and worm gear 42 with parallel shafts according to the principles of the present invention.

FIG. 28 is a plan view of a design with an enveloping worm gear transmission with less than 90 degrees between enveloping worm 43 axes and face worm gear 44 axes according to the principles of the present invention;

FIG. 29 is an isometric view of a design with an enveloping worm gear transmission with less than 90 degrees between enveloping worm 43 axes and face worm gear 44 axes according to the principles of the present invention;

In FIG. 18, FIG. 19 and FIG. 28, FIG. 29 said enveloping worm axis and said face gear axis are intersected. When we used 180 or less than 180 degrees of revolution of enveloping worm thread no modifications of concave surface of enveloping thread are needed in order to have good mesh between enveloping worm thread and face gear. For more than 90 degrees of convex surface of enveloping thread or more than 180 degrees of revolution of concave surface of enveloping worm thread it is necessary to reposition concave or convex surfaces of the enveloping worm thread. In FIG. 28, FIG. 28 said enveloping worm axis and said face gear axis have less than 90 degree angles. This is a non obvious usage of well known enveloping worm. By repositioning the enveloping worm thread from its original position, were it was generated by rolling of cutting edge around base circle into arrangement with face gear, mesh with face gear teeth becomes possible. To use this enveloping thread in different designs of new enveloping face transmission the surfaces of the thread can be repositioned into new positions with the same topology of surfaces. Surface repositioning of enveloping worm for different designs of enveloping face worm transmissions could be made by the same principals as described above for conventional enveloping worm transmission. In FIG. 20, FIG. 21 said enveloping worm axis and said face gear axis are crossed, but not intersected.

FIG. 24 and FIG. 25 are views of a design with an enveloping worm placed on the face of worm gear 40 with enveloping worm 39 threads having 90 degrees of revolution, where the enveloping worm 39 was designed for highest ratio 4:11 of enveloping worm transmission shown in FIG. 18, FIG. 19. Face gear 40 was generated by using lowest ratio 5:13. This design has good mesh but is different from FIG. 18, FIG. 19 gear teeth profile. The principle of design of enveloping face worm gear transmission when we use an enveloping worm generated with a different ratio than is used to generate face worm gear could be applied to different modifications of enveloping face worm gear transmissions.

FIG. 26, FIG. 27 shows an enveloping worm transmission with parallel shafts according to the principles of present invention. Enveloping worm 41 is in mesh with worm gear 42, which has a spherical shape. The topology of enveloping worm surfaces the same like shows for the worm 18 in the FIG. 13.

The thread of enveloping worm 35 in FIG. 20 and FIG. 21 has an inverted envelope, but it is the same thread of enveloping worm 18 from FIG. 13 after reposition of a surface of said thread from original position.

FIG. 28 and FIG. 29 shows an enveloping worm gear transmission with less than 90 degrees between axis of the worm 43 and axis of face worm gear 44, generated by the worm 43, having the same thread surfaces like enveloping worm 18 in FIG. 13 according to the principles of the present invention.

Result of described worm modification could apply to many different applications.

FIG. 30 shows a sectional view of the enveloping worm 45 in mesh with worm gear 46 where the worm gear 46 is smaller than enveloping worm 45. Enveloping worm 45 has more than one revolution of the thread or could be with more than one thread.

FIG. 31 shows a view of the enveloping worm 47 with an inverted envelope in mesh with worm gear 48 where an enveloping worm 47 is inside of worm gear48. The enveloping worm 47 has a spherical shape.

FIG. 32 shows a sectional view of worm gear 49 and 50 for different design combinations of the enveloping worm 47 inside of worm gear 48.

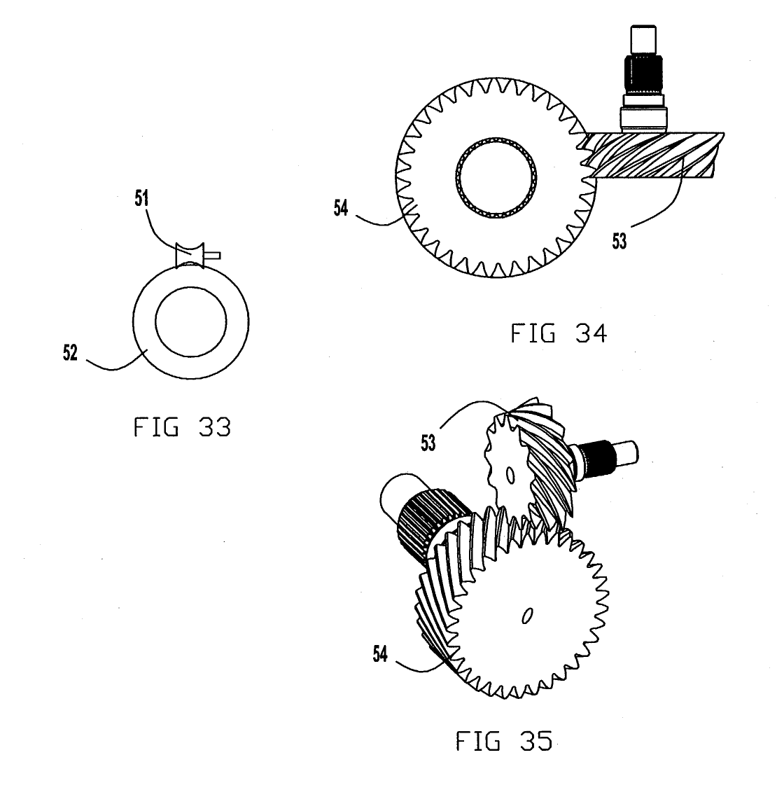

The above principles of surface repositioning of enveloping worm of conventional enveloping transmission applied to the design is shown in FIG. 33-FIG. 35 In FIG. 33 we have enveloping worm 51 thread with 360 degrees of revolution placed on top of worm gear 52. The enveloping worm 53 threads have less than 180 degrees of revolution and worm gear 54 has a profile of helical gear. This is also an example of predetermined gear profile used to generate the enveloping worm 53. The enveloping thread of said worm 53 has gradually changing thickness which is wide in the smaller lead angle part of said enveloping worm.

Enveloping worm transmission used in the present invention could also be self-locking. The term “self-locking” as it is utilized in this application to describe the inventive worm and worm gear combinations, means that the teeth of the worm gear, when in contact with the thread of the worm, are not capable of rotating the worm about the axis of the worm. Rotary motion can be provided only from the drive shaft to the enveloping worm and through the worm gear to the output shaft.

The preferable shape of the teeth and threads for the worm gear and the worm are shown in the drawings, but could be different. Even so, a worker of ordinary skill in the art would recognize that other shapes would come within the scope of this invention. In the present application, it is surface-to-surface contact between the worm gear teeth and the worm thread that increases the torque capacity of the enveloping worm transmission. The efficiency of the new worm/worm gear transmission is equal or even greater than in well-known hypoid gearing, which are used in right angle drives with low ratio.

For back drive, when the worm gear is a driven member and the enveloping worm is a driving member, this enveloping worm transmission also has high efficiency compared to a hypoid gearset. It was confirmed by testing of a steel enveloping worm transmission constructed according to the present invention that such transmissions can replace hypoid or bevel gearing in many applications. The lower noise of the enveloping worm transmission compared with hypoid and bevel gear transmissions make using the enveloping worm transmission of the present invention more beneficial, particularly in helicopter or in motor vehicle power train applications.

For the same pinion size, this invention can provide up to twice the torque capacity of hypoid gearing.

Up to now, those skilled in the art were of the opinion that an enveloping worm transmission requires unique machining technology that presents an insurmountable barrier to commercial applications. But now, by using more simplified worm thread with less than 180 degree of revolution it is possible to use existing technology for already producing gears, like for hypoid and spiral bevel gears.

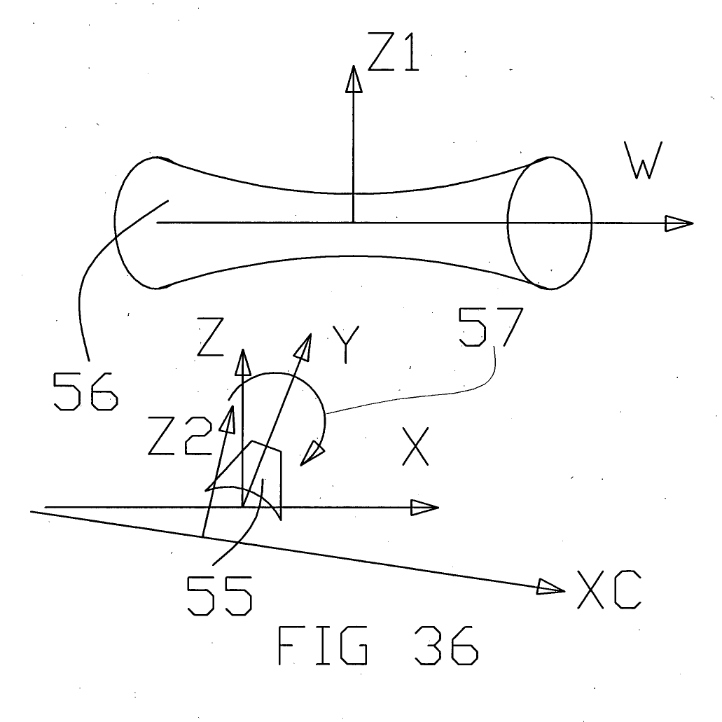

FIG. 36 shows an example of machine setting for manufacturing modified enveloping worm.

X, Y, Z is base coordinate system, placed in the middle of the base circle for cutting tool 55.

W is axis of rotation of worm's blank 56. Vector Z1 normal to cutting plane ZX is made from intersection of axis Y with axis W. Position 57 is the direction of turning to reposition cutter 55. To machine modified convex thread of the enveloping worm we need to turn cutter 55 around Y axis and then transfer along Y axis. New cutting plane for machining convex surface is defined by XC and Y axes and new position of vector Z1 is defined by Z2.

This set-up can be used to machine just one surface of enveloping worm thread, concave or convex. To machine the opposite surface (concave or convex) there will be a different set-up.

Machining the thread of enveloping worm by using Gleason or Oerlicon machines requires defining trajectory of motion for a cutting tool in order to generate concave and convex surfaces of the enveloping worm thread. Modified surfaces of enveloping worm thread could be designed and then manufactured using derived equations of the repositioned surfaces or by computer modeling or special setup of a machine according with the principles of present invention

The enveloping worm thread could also be generated by predetermined cutter profile, identical to a worm gear 54 profile. It could be helical teeth worm gear profile (U.S. Pat. No. 1,903,318, U.S. Pat. No. 2,935,886) from FIG. 31, FIG. 32 or any predetermined worm gear tooth profile. In this case we need to place a cutter in the position by repositioning it from original position according with the principal of the invention. The enveloping worm thread generation by predetermined cutter profile could be done in general by mathematical equations, computer simulations or real machining.

Worm gear generation (by hobing) could be used by a cutting tool with one thread or more than one of modified threads. If we use computer simulation to generate data we can use the same principles of reposition of predetermined enveloping worm surface into new position. Then we can generate a computer model of the worm gear by using already defined enveloping worm thread surfaces.

Taped shape of the enveloping worm and specially designed taped shape of the worm gear allows us to use very productive technology, like forging, or casting.

The basic inventive system of the present invention can be reconfigured into many different mechanical transmissions. For example, it can be used in a front axle drive and differential drive rear axle of a car, power windows, escalator drive, and more. The enveloping worm transmissions described above can be utilized in a power take-off unit of a four-wheel drive transaxle.

### General Advantages of Enveloping Worm Transmission

The above described transmission is transmitting more power with smaller size. It is a compact alternative for hypoid and spiral bevel gears in low ratio applications.

The invention has high torque capacity due surface to surface contact mesh that reduces contact stresses. Contact pattern of motion along the tooth line: from the left to the right or from the right to the left depending on the direction of rotation. In hypoid gears contact pattern of motion across the tooth: from the root to the tip or from the tip to the root depending on the direction of rotation. Enveloping gear has better lubrication condition (suction vs. squeezing out) that may reduce the cost in assembly and increase driving efficiency.

In automotive power train applications like front and rear drive axles, power take-off units, traction systems and mechanical amplifiers it saves space up to 30% and significantly reduces weight. It will work in power windows and power seats, steering drives.

In the traditional engineering practice enveloping (double enveloping) gears have been used with the ratio 1:5 and higher. Hypoid and spiral bevel gears are always been used in the lower ratio applications. For the ratio less than 1:5 invention can be more efficient than a right angle gear. Enveloping worm transmission has higher percentage rolling/sliding motion and excellent dynamic lubrication. It has extending life even without lubrication. Invention can replace any right angle gears, especially in power sensitive applications, like helicopters, ships, boats and cars.

Most of the time each thread of the enveloping worm is in mesh longer than any other known gear's pinions. It reduces impact of engagement and disengagement, increases the contact ratio and makes quieter motion.

Using existing gear cutting machines can make enveloping worm transmission chipper than hypoid or spiral bevel gears. For some configuration forging technology or power metallurgy could be applied as well. There are very broad opportunities for the enveloping worm transmission made from plastic.

In the invention being thus described, it is obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An enveloping worm transmission comprising: a worm gear and an enveloping worm, said enveloping worm having at least one screw thread that is engaged by at least one tooth of said worm gear where said enveloping thread of said enveloping worm modified by reposition of a surface of said thread from original position.

2. The enveloping worm transmission as recited in claim 1 wherein said enveloping worm having 360 degrees or less than 360 degrees of a thread revolution with concave surface on one side where concave surface of said enveloping worm thread is modified by reposition from original position.

3. The enveloping worm transmission as recited in claim 1 wherein said enveloping worm having 360 degrees or less than 360 degrees of a thread revolution with convex surface on one side where convex surface of said enveloping worm thread is modified by reposition from original position.

4. The enveloping worm transmission as recited in claim 1 wherein said enveloping worm having 360 degrees or less than 360 degrees of a thread revolution with concave surface on one side and convex surface on another side where concave surface of said enveloping worm thread is modified by reposition from original position and convex surface of said enveloping worm thread is modified by reposition from original position.

5. The enveloping worm transmission as recited in claim 1 wherein said enveloping worm having 360 degrees or more than 360 degrees of a thread revolution with concave surface on one side where concave surface of said enveloping worm thread is modified by reposition from original position.

6. The enveloping worm transmission as recited in claim 1 wherein said enveloping worm having 360 degrees or more than 360 degrees of a thread revolution with convex surface on one side where convex surface of said enveloping worm thread is modified by reposition from original position.

7. The enveloping worm transmission as recited in claim 1 wherein said enveloping worm having 360 degrees or more than 360 degrees of a thread revolution with concave surface on one side and convex surface on another side where concave surface of said enveloping worm thread is modified by reposition from original position and convex surface of said enveloping worm thread is modified by reposition from original position.

8. The enveloping worm transmission as recited in claim 1 wherein said enveloping worm having 180 degrees or less than 180 degrees of a thread revolution with concave surface on one side where concave surface of said enveloping worm thread is modified by reposition from original position.

9. The enveloping worm transmission as recited in claim 1 wherein said enveloping worm having 180 degrees or less than 180 degrees of a thread revolution with convex surface on one side where convex surface of said enveloping worm thread is modified by reposition from original position.

10. The enveloping worm transmission as recited in claim 1 wherein said enveloping worm having 180 degrees or less than 180 degrees of a thread revolution with concave surface on one side and convex surface on another side where concave side of said enveloping worm thread is modified by reposition from original position and convex surface of said enveloping worm thread is modified by reposition from original position.

11. The enveloping worm transmission as recited in claim 1 wherein said enveloping worm having 90 degrees or less than 90 degrees of a thread revolution with concave surface on one side where concave surface of said enveloping worm thread is modified by reposition from original position.

12. The enveloping worm transmission as recited in claim 1 wherein said enveloping worm having 90 degrees or less than 90 degrees of a thread revolution with convex surface on one side where convex surface of said enveloping worm thread modified by reposition from original position.

13. The enveloping worm transmission as recited in claim 1 wherein said enveloping worm having 90 degrees or less than 90 degrees of a thread revolution with concave surface on one side and convex surface on another side where concave surface of said enveloping worm thread is modified by reposition from original position and convex surface of said enveloping worm thread is modified by reposition from original position.

14. The enveloping worm transmissions as recited in claim 10, wherein said thread with 180 degrees or less than 180 degrees of said enveloping thread revolution has the biggest lead angle of said enveloping thread with concave surface.

15. The enveloping worm transmissions as recited in claim 13, wherein said thread with 90 degrees or less than 90 degrees of said enveloping thread revolution has the smallest lead angle of said thread with concave surface.

16. The enveloping worm transmissions as recited in claim 1, wherein said enveloping worm has an inverted envelope.

17. The enveloping worm transmission as recited in claim 16 wherein said worm gear has teeth on an inner surface of a hole meshed with an inverted enveloping worm inserted in said hole.

18. An enveloping worm transmission comprising: a worm gear and an enveloping worm, with said enveloping worm having at least one thread that is engaged by at least one tooth of said worm gear wherein said worm gear is a face gear and a said enveloping worm in a face arrangement with said worm gear.

19. The enveloping worm transmission as recited in claim 18, wherein said thread has 180 degrees or less than180 degrees of revolution.

20. The enveloping worm transmission as recited in claim 18, wherein said thread has 90 degrees or less than 90 degrees of revolution.

21. The enveloping worm transmission as recited in claim 18, wherein said enveloping worm axis and said face gear axis are intersected.

22. The enveloping worm transmission as recited in claim 18, wherein said enveloping worm axis and said face gear axis are crossed.

23. The enveloping worm transmission as recited in claim 18, wherein said enveloping worm axis and said face gear axis have 90 degrees or less than 90 degree angles.

24. The enveloping worm transmission as recited in claim 18, wherein said enveloping worm axis and said face gear axis are parallel.

25. The enveloping worm transmissions as recited in claim18, wherein said enveloping worm has an inverted envelope.

26. The enveloping worm transmission as recited in claim 18, wherein said enveloping worm is relocated from its original position into face arrangement with said worm gear.

27. The enveloping worm transmission as recited in claim 26 wherein said enveloping worm having 360 degrees or less than 360 degrees of a thread revolution with concave surface on one side where concave surface of said enveloping worm thread is modified by reposition from original position.

28. The enveloping worm transmission as recited in claim 26 wherein said enveloping worm having 360 degrees or less than 360 degrees of a thread revolution with convex surface on one side where convex surface of said enveloping worm thread is modified by reposition from original position.

29. The enveloping worm transmission as recited in claim 26 wherein said enveloping worm having 360 degrees or less than 360 degrees of a thread revolution with concave surface on one side and convex surface on another side where concave surface of said enveloping worm thread is modified by reposition from original position and convex surface of said enveloping worm thread is modified by reposition from original position.

30. The enveloping worm transmission as recited in claim 26 wherein said enveloping worm having 360 degrees or more than 360 degrees of a thread revolution with concave surface on one side where concave surface of said enveloping worm thread is modified by reposition from original position.

31. The enveloping worm transmission as recited in claim 26 wherein said enveloping worm having 360 degrees or more than 360 degrees of a thread revolution with convex surface on one side where convex surface of said enveloping worm thread is modified by reposition from original position.

32. The enveloping worm transmission as recited in claim 26 wherein said enveloping worm having 360 degrees or more than 360 degrees of a thread revolution with concave surface on one side and convex surface on another side where concave surface of said enveloping worm thread is modified by reposition from original position and convex surface of said enveloping worm thread is modified by reposition from original position.

33. The enveloping worm transmission as recited in claim 26 wherein said enveloping worm having 180 degrees or less than 180 degrees of a thread revolution with concave surface on one side where concave surface of said enveloping worm thread is modified by reposition from original position.

34. The enveloping worm transmission as recited in claim 26 wherein said enveloping worm having 180 degrees or less than 180 degrees of a thread revolution with convex surface on one side where convex surface of said enveloping worm thread is modified by reposition from original position.

35. The enveloping worm transmission as recited in claim 26 wherein said enveloping worm having 180 degrees or less than 180 degrees of a thread revolution with concave surface on one side and convex surface on another side where concave side of said enveloping worm thread is modified by reposition from original position and convex surface of said enveloping worm thread is modified by reposition from original position.

36. The enveloping worm transmission as recited in claim 26 wherein said enveloping worm having 90 degrees or less than 90 degrees of a thread revolution with concave surface on one side where concave surface of said enveloping worm thread is modified by reposition from original position.

37. The enveloping worm transmission as recited in claim 26 wherein said enveloping worm having 90 degrees or less than 90 degrees of a thread revolution with convex surface on one side where convex surface of said enveloping worm thread modified by reposition from original position.

38. The enveloping worm transmission as recited in claim 26 wherein said enveloping worm having 90 degrees or less than 90 degrees of a thread revolution with concave surface on one side and convex surface on another side where concave surface of said enveloping worm thread is modified by reposition from original position and convex surface of said enveloping worm thread is modified by reposition from original position.

39. The enveloping worm transmissions as recited in claim 35, wherein said thread with 180 degrees or less than 180 degrees of said enveloping thread revolution has the biggest lead angle of said enveloping thread with concave surface.

40. The enveloping worm transmissions as recited in claim 38, wherein said thread with 90 degrees or less than 90 degrees of said enveloping thread revolution has the smallest lead angle of said thread with concave surface.

41. Machining of an enveloping worm thread including generation of said enveloping worm thread surface by a cutter rolls around a base circle on a cutting plane with simultaneous rotation of an enveloping worm blank around an axis of said enveloping worm, including placement of said cutter in a new position defined by reposition of cutting plane from original position to said position.

42. Machining of said enveloping worm thread as recited in claim 41, where said reposition of said cutter from original position into said new position is defined by turning said cutter relative to said base coordinate system and said enveloping worm axis of rotation.

43. Machining of said enveloping worm thread as recited in claim 41, where said reposition of said cutter from original position into said new position is defined by transferring said cutter relative to said base coordinate system and enveloping worm axis of rotation.

44. Machining of said enveloping worm thread as recited in claim 41, where said reposition of said cutter from original position into said new position is defined by combinations of transferring and turning said cutter relative to said base coordinate system and said enveloping worm axis of rotation.

45. Machining of said enveloping worm thread as recited in claim 41, wherein placement of said cutter in said new position is for machining said convex surface of said enveloping worm thread.

46. Machining of said enveloping worm thread as recited in claim 41, wherein placement of said cutter in said new position is for machining said concave surface of said enveloping worm thread.

47. Machining of said enveloping worm thread as recited in claim 41, wherein placement of said cutter in said new position is for machining said convex and concave surfaces of said enveloping worm thread.

48. Machining of said enveloping worm thread as recited in claim 41, wherein said cutter has helical tooth surface.

49. Machining of said enveloping worm thread as recited in claim 41, wherein said enveloping thread of said enveloping worm has less than 360 degrees of revolution.

50. Machining of said enveloping worm thread as recited in claim 41, wherein said thread of said enveloping worm has 180 degrees or less than 180 degrees of revolution of said thread.

51. Machining of said enveloping worm thread as recited in claim 41, wherein said thread of said enveloping worm has 90 degrees or less than 90 degrees of revolution of said thread.
